(19) United States
(12) Patent Application Publication
(10) Pub. No.: US 2025/0353130 A1
(43) Pub. Date: Nov. 20, 2025

(54) MACHINING CENTRE FOR THE MECHANICAL PROCESSING OF WORKPIECES

(71) Applicant: MG Beteiligungsgesellschaft mbH, Geislingen/Steige (DE)

(72) Inventors: Magnus GRÜNER, Geislingen/Steige (DE); Tobias GRÜNER, Geislingen/Steige (DE)

(21) Appl. No.: 19/206,887

(22) Filed: May 13, 2025

(30) Foreign Application Priority Data
May 15, 2024 (EP) 24175996.8

(51) Int. Cl. B23Q 16/06; B23Q 3/155; B23Q 3/157; B23Q 5/32; B23Q 7/08; B23Q 39/00

(52) U.S. Cl. CPC B23Q 16/06; B23Q 3/15539; B23Q 3/1554; B23Q 3/15793; B23Q 5/32; B23Q 7/08; B23Q 2039/006

(57) ABSTRACT

A machining centre, with a first machining unit formed in a Z-axis direction of a coordinate system formed by three mutually perpendicular axis directions X, Y, Z, and equipped with a machining tool arranged in a machining zone, and a first tool slide movable in an X-axis and Y-axis direction, which can be equipped with a clamping device. The first tool slide has a drive spindle, and the clamping device is rotatable about a first axis of rotation. A second machining unit is operable independently of the first machining unit, and has a second tool slide movable independently of the first tool slide in the Z-axis direction, and a second workpiece positioning unit movable independently of the first workpiece positioning unit in the X-axis and Y-axis direction movable independently of the first tool slide in the Z-axis direction and a second workpiece positioning unit.

### CROSS REFERENCE TO RELATED APPLICATION

The present application claims the benefit of European application EP 24175996.8, filed May 15, 2024, which is incorporated herein by reference.

### BACKGROUND OF THE INVENTION

The invention relates to a machining centre for the mechanical processing of workpieces, with a first machining unit which can be moved in a Z-axis direction of a coordinate system formed by three perpendicular axis directions X, Y, Z, with a machining tool for machining a workpiece in a Z-axis direction of a coordinate system formed by three perpendicular axis directions X, Y, Z, which has a first tool slide that can be moved in a Z-axis direction of a coordinate system formed by three perpendicular axis directions X, Y, Z and can be equipped with a machining tool for machining a workpiece arranged in a machining zone, and a first workpiece positioning unit that can be moved in an X-axis direction and in a Y-axis direction and which can be equipped with a clamping device for receiving and clamping the workpiece to be machined, wherein the first tool slide has a drive spindle which can be driven in a rotational movement for supplying drive energy to the machining tool, and wherein the clamping device can be rotated about a first axis of rotation.

Such machining centres have been known for a long time. Such machining centres are used for the mechanical, in particular chip-removing, machining of workpieces. Such multi-axis NC-capable machine tools are suitable for the complete machining of workpieces, whereby the functions of a lathe, a milling machine and a drilling machine are usually included.

A machining centre of the type mentioned above is known, for example, from EP 0 767 721 B1. The machining centre disclosed therein has a working unit that can be moved in the Z-axis direction and can be equipped with a machining tool, for example in the form of a drill. The machining tool can be used to machine a workpiece arranged in a machining zone, which can be positioned in the machining zone relative to the machining tool with the aid of a positioning device. The workpiece is held in place by a clamping device. The positioning device can be moved in the X-axis direction and also has a Y-axis and a rotation axis. The positioning device is designed to move the coupled workpiece between the machining zone and a workpiece changing station located outside the machining zone, where a workpiece change between workpieces to be machined and workpieces that have already been machined takes place, for example with the aid of a gripper.

### SUMMARY OF THE INVENTION

The object of the invention is to provide a machining centre of the type mentioned above, with which shorter cycle times can be achieved compared to conventional machining centres, so that the output of the workpieces and the overall productivity of the machining centre can be increased. Furthermore, greater energy efficiency is to be achieved compared to conventional machining centres.

This object is solved by a machining centre with the features of independent claim 1. Further developments of the invention are described in the subclaims.

The machining centre according to the invention is characterised in that that a second machining unit is provided which can be operated independently of the first machining unit, is arranged adjacent to the first machining unit in the X-axis direction and has a second tool slide which can be moved independently of the first tool slide in the Z-axis direction, as well as a second workpiece positioning unit which can be moved independently of the first workpiece positioning unit in the X-axis direction and Y-axis direction.

This makes it possible to machine two workpieces simultaneously in the machining centre. The machining variability is enormous. For example, it is possible to machine a workpiece of a first type with one of the machining units and a workpiece of a second type with the other machining unit at the same time. Furthermore, it is often necessary to machine the tools using different clamping arrangements, whereby, for example, a first clamping arrangement of the workpiece is used to machine areas of the circumference, while another clamping arrangement is provided for machining the workpiece on the front side. It is therefore possible to machine a workpiece in the first clamping arrangement with one machining unit and a workpiece of the same type in the second clamping arrangement with the other machining unit at the same time.

Overall, the parallel machining of two workpieces increases the productivity of the machining centre compared to conventional machining centres.

In a further development of the invention, the machining units are assigned a common guide device for movements in the X-axis direction that can be performed independently of each other. It is expedient for components of the guide device to be assigned to both machining units, while other components are assigned to only one of the machining units.

It is advantageous for the guide device to extend along the X-axis direction above the first and second tool slides.

In a particularly preferred embodiment, the guide device has at least one guide rail extending in the X-axis direction, on which the first and second workpiece positioning units can be moved back and forth independently of each other by means of X-axis drives assigned to the workpiece positioning units. Due to the considerable weight of the workpiece positioning units and the requirements for precise positioning, several guide rails are provided for guiding the workpiece positioning units, for example two or three in number.

The X-axis drives are conveniently designed as linear drives, for example in the form of linear motors. Here too, it is convenient to assign components of the linear drives to both machining units, i.e. both workpiece positioning units, for example in the form of permanent magnet segments extending along the guide rails in the X-axis direction. It is then appropriate for the rotor of the linear motor to be located on the movable workpiece positioning units.

It is possible for the guide device to have two X-axis drives in the form of linear motors, one of which is assigned to the first workpiece positioning unit and the other to the second workpiece positioning unit. However, it is particularly preferred that the guide device has a total of four X-axis drives, in particular designed as linear motors, of which two linear motors are assigned to the first workpiece positioning unit and the other two linear motors are assigned to the second workpiece positioning unit. The selection of the number of linear motors depends largely on the power that can be called up by the linear motors, so that it is appropriate to use two linear motors per workpiece positioning unit for particularly heavy workpiece positioning devices.

In a further development of the invention, the workpiece positioning units each have a cross slide mounted on the at least one guide rail of the guide device so that it can be moved in the X-axis direction, and a Y-slide mounted on the cross slide so that it can be moved in the Y-axis direction. It is expedient for the cross slide to be mounted on two or three guide rails of the guide device.

In a particularly preferred embodiment, the respective cross slide has a Y-axis drive for driving the associated Y-slide in the Y-axis direction. The Y-axis drive is advantageously designed as a linear drive, in particular a Y-spindle drive. However, other types of linear drives other than spindle drives can also be used.

In a further development of the invention, the workpiece positioning units each have a rotary drive, arranged in particular on board the respective Y-slide, for initiating a rotary movement on the coupled clamping device and the first rotary axis. This makes it possible to position the workpiece in the X-axis direction, in the Y-axis direction and, in addition, to rotate it about at least one rotary axis. The machining tool is then fed to the workpiece to be machined in the Z-axis direction with the aid of the tool slide. Conveniently, the first rotational axis extends in the Y-axis direction.

Like the workpiece positioning units, which are made up of several parts consisting of a cross slide and a Y-slide, the Y-slides are also made up of several parts. Conveniently, the Y-slides each have a base body and a rotary table that can rotate around the first axis of rotation and is mounted on the base body. It is advantageous for the rotational movement about the first axis of rotation to be generated by a rotary drive arranged on board the Y-slide and thus moved in the Y-axis direction when the Y-slide moves, and to be transmitted to the rotary table. A belt-driven rotary drive with a spline gear is suitable as a rotary drive, for example.

In a particularly preferred embodiment, the rotary table has a rotary table interface for coupling with the clamping device. The clamping devices are components that are individually tailored to the workpiece to be machined, which means that they need to be replaceable in the same way as the workpieces to be machined or the machined workpieces.

In a particularly preferred embodiment, the clamping device of a respective workpiece positioning unit has a workpiece pallet designed with a counter interface for coupling with the rotary table interface and a clamping unit connected to the workpiece pallet and having several workpiece clamping elements, wherein the clamping elements are movable between a release position and a clamping position in which they clamp the workpiece to be machined. The clamping unit is advantageously a hydraulic clamping unit in which the movement of the clamping elements is effected by hydraulic pressure.

In a further embodiment of the invention, an exchange shuttle is provided for changing workpieces or clamping devices, wherein the exchange shuttle is movable, in particular linearly movable, between a standby position and an exchange position located in the machining zone, wherein in the exchange position either at least one machined workpiece or at least one clamping device to be exchanged can be taken over by the exchange shuttle or at least one raw workpiece or at least one clamping device to be exchanged can be transferred to at least one workpiece positioning unit.

It is particularly advantageous if the transfer of workpieces or clamping devices or the transfer of workpieces or clamping devices can be carried out synchronously, i.e. simultaneously at both workpiece positioning units. Of course, the changeover at one workpiece positioning unit can also be carried out after the changeover at the other workpiece positioning unit. The prerequisite for a synchronous changeover at both workpiece positioning units is the simultaneous provision of two workpieces or clamping devices by the changeover shuttle.

In a particularly preferred embodiment, the exchange shuttle has several loading stations for receiving workpiece carriers or fixture carriers, wherein the workpiece carriers are empty or loaded with workpieces, and wherein the fixture carriers are empty or loaded with clamping devices. Conveniently, in the change position, the loading stations of the exchange shuttle assigned to the first and/or second workpiece positioning units are moved into the machining zone either unloaded, in order to take over a machined workpiece or a clamping device to be replaced, or loaded, in order to transfer a workpiece to be machined or a clamping device to be replaced to the assigned workpiece positioning unit.

It is advantageous for the workpiece carrier to have a holding device with which a workpiece or a raw workpiece can be held, wherein the holding device has several holding elements which are movable between a holding position in which they fix the associated workpiece on the workpiece carrier and a release position. The holding elements can, for example, be designed as spring clamping elements. It is also useful for the device carrier to have a holding device with which a clamping device to be replaced or a clamping device to be inserted can be held, wherein the holding device also has several holding elements which can be moved between a holding position in which they fix the clamping device to the device carrier and a release position. Here too, the holding elements can be designed as spring clamping elements.

In a further development of the invention, the exchange shuttle has a rotary indexing table which is rotatable in particular about a rotational axis extending in the Y-axis direction, wherein the exchange shuttle has at least four loading positions, of which two are located in the processing zone in the exchange position in such a way that a transfer or takeover is possible, and then, by rotating the rotary indexing table, the two other loading positions can be swung into the processing zone. Switching between the pairs of loading positions is conveniently carried out by moving the exchange shuttle a short distance out of the processing zone and then rotating the rotary indexing table about the axis of rotation.

The movement of the exchange shuttle between the standby position and the change position in the processing zone is preferably a linear movement, in particular in the Z-axis direction. A shuttle linear drive, which can be designed as a shuttle spindle drive, for example, is used to perform this linear movement. A rotary drive conveniently located on board the exchange shuttle is used for the rotary movement of the rotary indexing table.

It is possible for the exchange shuttle to be movable linearly in the Z-axis direction, with the workpiece positioning unit being arranged between the workpiece slide and the exchange shuttle.

It is possible that the clamping device and thus a workpiece clamped to the clamping device for machining can be rotated about the first axis of rotation extending in the Y-axis direction. In such a configuration with the three spatial axes X, Y, Z and the first axis of rotation as machining axes, four-axis machining takes place.

Furthermore, it is possible for the clamping device and thus the workpiece clamped for machining to rotate about the first axis of rotation extending in the Y-axis direction and additionally about a second axis of rotation extending in the Z-axis direction. In this configuration, five-axis machining takes place. The flexibility of the machining centre according to the invention makes it possible to clamping devices for four-axis machining can be exchanged for clamping devices for five-axis machining and vice versa, whereby four-axis machining is possible in both machining units or five-axis machining is possible in both machining units or, in a hybrid manner, four-axis machining is possible in one machining unit and five-axis machining is possible in the other machining unit.

In a further development of the invention, a machining tool coupled to the associated tool slide can be moved between the machining zone and a tool change position by means of a Z-axis guide device. The machining tool can be, for example, a single-spindle or multi-spindle tool, for example in the form of a multi-spindle drilling head. Alternatively, however, the machining tool can also be designed as a milling tool in a single-spindle or multi-spindle design.

The Z-axis guide device preferably has at least one guide rail extending in the Z-axis direction, by means of which the associated tool slide can be moved between the machining zone and the tool change position by means of a Z-axis drive. The Z-axis guide device conveniently has two guide rails. The Z-axis drive is conveniently designed as a linear drive, for example as a Z-spindle drive.

In a further development of the invention, the drive spindle can be driven by a tool drive motor which is on board the tool slide. The tool drive motor is therefore conveniently moved with the tool slide when the tool slide moves in the Z-axis direction.

In a further development of the invention, a tool changer is provided, with which a tool change can be carried out synchronously on the first tool slide and the second tool slide when these are in the tool change position. It is expedient for the tool changer to be mounted between a tool magazine and the at least one tool slide for transfer or reception of machining tools so that it can be rotated about a changer axis of rotation by means of a rotary drive device. The rotary drive device conveniently has a rotary drive with which a rotary movement can be initiated on the tool changer, in particular with the aid of a gear transmission.

In a particularly preferred embodiment, the tool changer has at least two change arms, each of which is assigned to one of the tool slides and each of which has a changer clamping device. With the aid of the tool changer clamping device, a machining tool located in the tool magazine can be picked up and held or clamped on the change arm of the tool changer.

Conveniently, the change arms can each be moved between a working position, in which a machining tool can be transferred to or from the tool slide or to or from the tool magazine, and a transit position, in which the tool changer can be rotated about the changer axis of rotation. The exchange arms can be moved in particular along the Y-axis direction.

In a particularly preferred embodiment, the tool changer has a base body with an outer surface on which at least two pairs of exchange arms are arranged in such a way that the planes spanned by the two exchange arms of a pair of exchange arms are at an angle, in particular perpendicular, to each other.

It is advantageous to have one pair of exchange arms on a tool magazine and one pair of exchange arms on the tool slide. The exchange positions of the tool slides and the tool magazines can be approached synchronously via the pairs of exchange arms. It is advantageous to hold four machining tools synchronously, two of which are to be replaced by the tool slide and two of which are to be replaced by the tool magazine. In the following cycle, the four machining tools can then be transferred synchronously, i.e. the two machining tools to be replaced are transferred to the tool slides, while at the same time the two machining tools to be replaced are transferred to a second tool magazine.

In a further development of the invention, at least one tool magazine is provided for storing machining tools, comprising two tool change positions, with each tool change position being assigned to a respective change arm. It is advantageous to provide two tool magazines, with the tool magazines being part of both machining units. The two tool magazines can therefore be assigned to both machining units in such a way that machining tools to be exchanged alternately are either taken from one tool magazine or from the other tool magazine or tools to be replaced are deposited there.

In a further development of the invention, the machining centre has a control device with which all movement sequences can be monitored, controlled or regulated. The movement sequences include, for example, the machining of a workpiece located in the machining zone and thus the positioning of the workpiece positioning unit in the X-axis direction, the Y-axis direction and, if necessary, the rotational position of the rotary table, as well as the positioning of the tool slide in the Z-axis direction. This also includes the movements involved in inserting or replacing workpieces or clamping devices and in inserting or replacing tools. It is useful for the machining centre to have various measuring systems, one of which is designed as an X-axis measuring system, one as a Y-axis measuring system and one as a Z-axis measuring system. Corresponding measuring systems are also assigned to the rotary axes.

The control device can, for example, be designed in the form of a programmable logic controller (PLC unit).

### BRIEF DESCRIPTION OF THE DRAWINGS

A preferred embodiment of the invention is shown in the drawing and explained in more detail below. The drawing shows:

FIG. 1 a perspective view of the essential components of a preferred embodiment of the machining centre according to the invention,

FIG. 2 a front view of the machining tool from FIG. 1,

FIG. 3 a front view of the machining tool from FIG. 1 without clamping devices,

FIG. 4 a side view of the machining centre from FIG. 1,

FIG. 5 an enlarged and partially sectioned view of detail X from FIG. 4,

FIG. 6 a top view of the machining centre from FIG. 1,

FIG. 7 is a perspective view of a first embodiment of a clamping device of the machining centre according to the invention, and

FIG. 8 is a perspective view of a second embodiment of a clamping device of the machining centre according to the invention.

### DETAILED DESCRIPTION

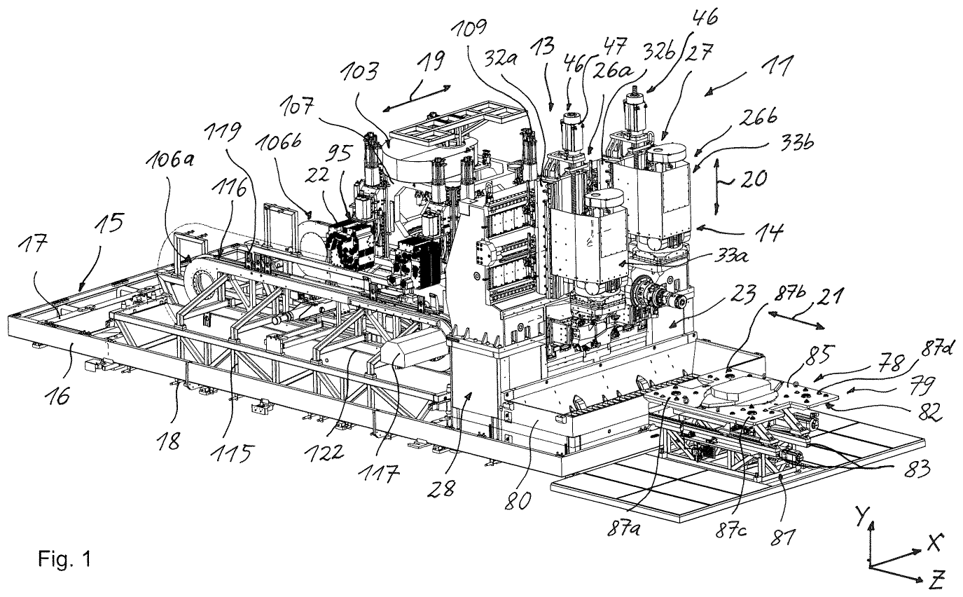

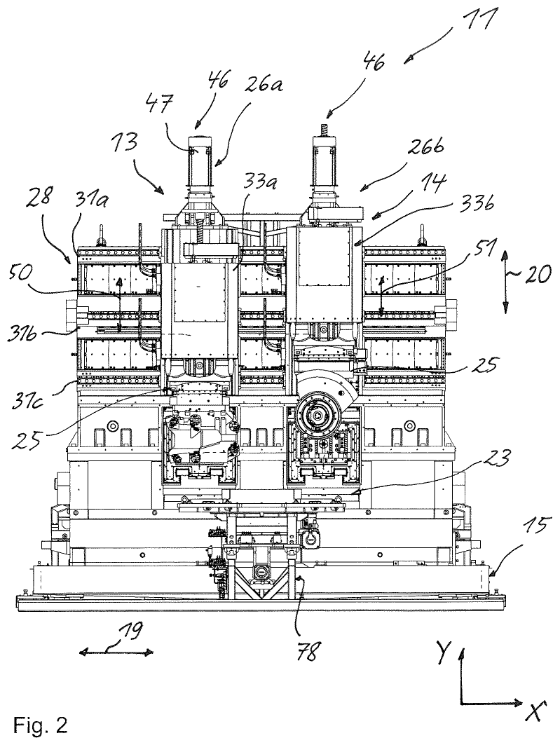

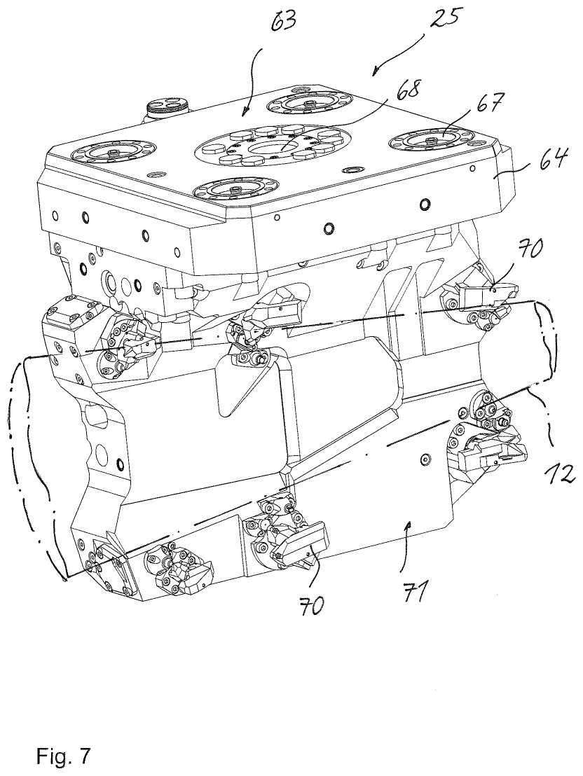

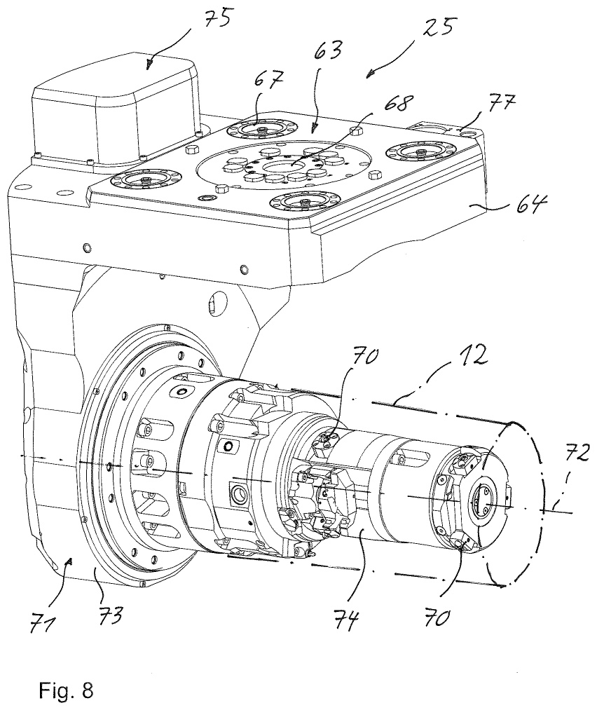

FIGS. 1 to 8 show a preferred embodiment of the machining centre 11 according to the invention for the mechanical, in particular chip-removing, machining of workpieces 12. The workpieces 12 shown only schematically in FIGS. 7 and 8 may be, for example, gearbox housings, clutch housings, electric motor housings or steering housings. However, this is only an exemplary list of the different types of workpieces. Other types of workpieces not mentioned here can also be machined with the machining centre 11 according to the invention.

The core of the machining centre 11 consists of two machining units, a first machining unit 13 and a second machining unit 14 arranged adjacent to the first machining unit 13 in the X-axis direction of a coordinate system formed by three perpendicular axis directions X, Y, Z. The machining units 13, 14 are essentially identical to each other with regard to the non-interchangeable components, which will be discussed in more detail below.

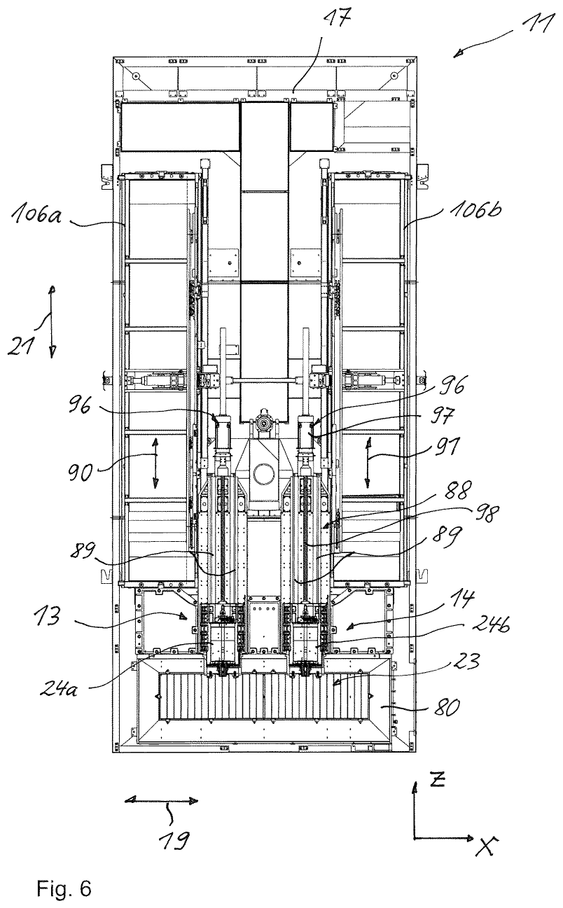

As shown in particular by the combined view of FIGS. 1 and 6, the machining centre 11 has a basic rack 15 with a base frame 16 forming the lateral outer closure, from the inner wall of which numerous base struts 17 extend between two opposite frame parts of the base frame 16. The base struts 17 extend essentially in a plane defined by the X-axis direction 19 and the Z-axis direction 21. On the undersides of the base struts 17 and, if necessary, on the undersides of the outer frame parts, there are support elements (not shown) on which the entire machining centre 11 rests on the ground. The support elements are height-adjustable in the Y-axis direction 20, which allows the machining centre 11 to be aligned precisely horizontally even on uneven ground. Actuating elements 18 protruding outwards from the outer wall of the frame parts are used to adjust the height of the support elements, which makes height adjustment relatively easy due to the good accessibility of the actuating elements 18.

As shown in particular in FIG. 1, the two machining units 13, 14 are mounted on the basic rack 15. The first machining unit 13 has a first tool slide 24a that can be moved in the Z-axis direction 21, which can be equipped with a machining tool 22 for processing a workpiece 12 arranged in a processing zone 23, and a first workpiece positioning unit 26a that can be moved in an X-axis direction 19 and in a Y-axis direction 20 and which can be equipped with a clamping device 25 for receiving and clamping the workpiece 12 to be machined. The second machining unit 14 can be operated independently of the first machining unit and is located in the X-axis direction 19, extending along the Z-axis direction adjacent to the first machining unit 13.

The second machining unit 14 has a second tool slide 24b that can be moved in the Z-axis direction, which can also be equipped with a machining tool 22, and a second workpiece positioning unit 26b, which can be moved in the X-axis direction 19 and in the Y-axis direction 20 and which can also be equipped with a clamping device for receiving and clamping the workpiece 12 to be machined.

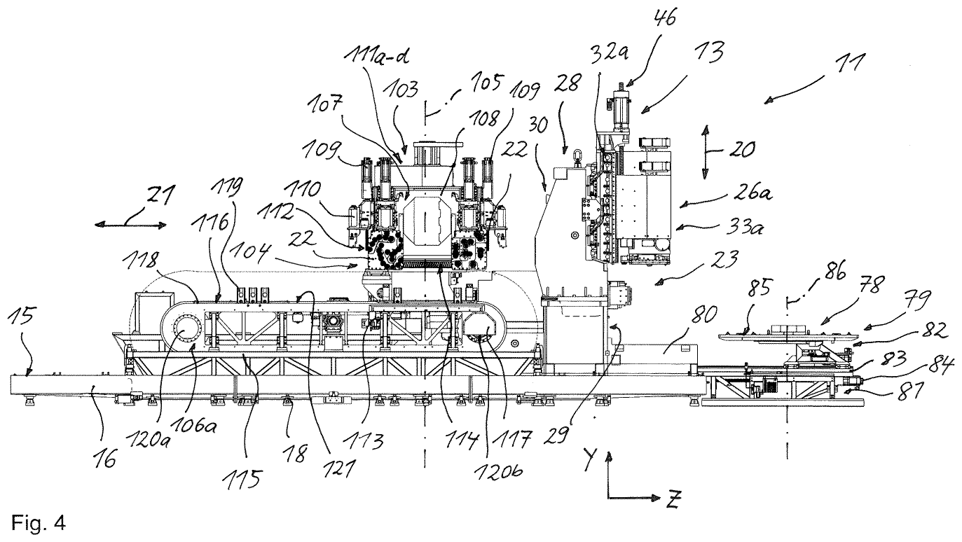

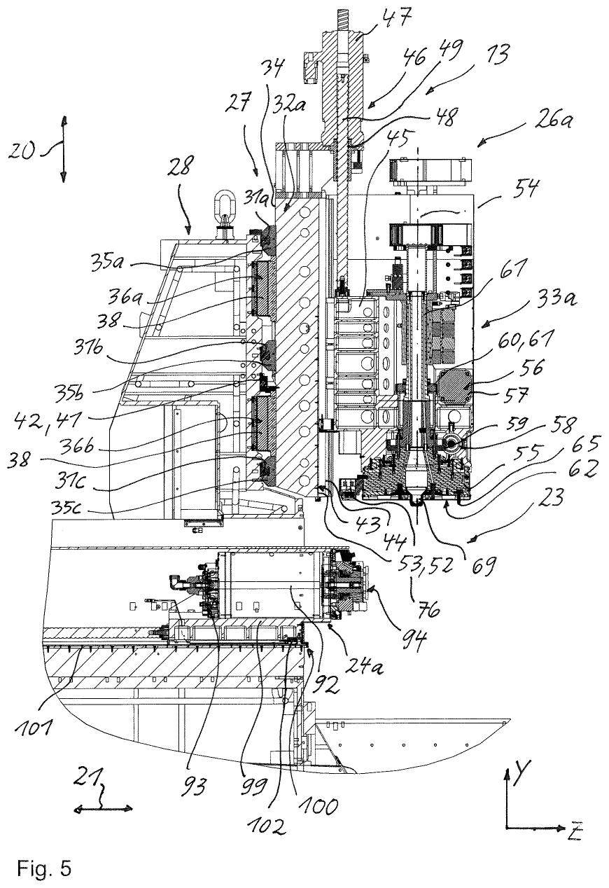

As shown in particular in FIGS. 1 and 5, the machining units 13, 14 are assigned a common guide device 27 for movements in the X-axis direction 19 that can be carried out independently of one another. The guide device 27 is located on a machine bed arranged on the basic rack 15, which in the present case is designed as a vertical bed. The machine bed 28 extends essentially over the entire width of the base frame 15 and has a front side 29 (FIG. 4) on which the guide device 27 is arranged. Opposite the front side 29 is a rear side 30 (FIG. 4). The machine bed 28 separates the two machining units 23 into a front area on the workpiece side, in which workpieces 12 are machined by the associated machining tools 22 in the machining zone 23, and a rear area on the tool side, in which the machining tools 22 are handled, as described in more detail below. Only the tool slides 24a, 24b move back and forth between the rear tool-side area and the front workpiece-side area in the manner described in more detail below, while all other components remain on their respective sides.

The guide device 27, which could also be referred to as the X-guide device, is arranged at the front of the machine bed 28, as already mentioned above, and extends overall above the travel plane of the two tool slides 24a, 24b. This means that the two workpiece positioning units 26a, 26b hang above the tool slides 24a, 24b, and the workpiece 12 to be machined is therefore machined in a suspended position. The guide device 27 has several guide rails 31a, 31b, 31c, in the example shown three, which are each fastened on one side to the front side 29 of the machine bed 28 and on the other side engage with the two workpiece positioning units 26a, 26b in the manner described below.

As already mentioned, each machining unit 13, 14 has a workpiece positioning unit 26a, 26b. Both workpiece positioning units 26a, 26b are guided so that they can move linearly along the guide rails 31a-c in the X-axis direction 19.

The first workpiece positioning unit 26a has a first cross slide 32a and a first Y slide 33a mounted on the first cross slide 32a so as to be movable in the Y-axis direction 20. The second workpiece positioning unit 26b has a second cross slide 32b, which is also mounted so as to be movable along the guide rails 31a-c, and a second Y-slide 33b mounted on the second cross slide 32b so as to be movable in the Y-axis direction 19.

The two cross slides 32a, 32b are very solid components, for example made of suitable cast material, as they each have to carry the two associated Y-slides 33a, 33b.

The two cross slides 32a, 32b each have a cross slide rear wall 34 assigned to the guide rails 31a-c, to which, as shown in particular in FIG. 5, guide shoes 35a-c are fastened, which surround the assigned guide rails 31a-c, whereby the cross slide 32a, 32b are mounted on the machine bed 28 and guided so as to be linearly movable in the X-axis direction 19 via the guide rails 31a-c. The design and arrangement of the guide shoes 35a-c is identical on both cross slides 32a, 32b. As already mentioned, the two workpiece positioning devices 26a, 26b are actively driven and mounted so as to be movable independently of one another in the X-axis direction 19 along the guide rails 31a-c.

For drive purposes, each workpiece positioning unit 26a, 26b is assigned at least one X-axis drive 36a, 36b (FIG. 5), which in the example shown are designed as linear drives in the form of linear motors. In the example shown, two linear motors are assigned to each workpiece positioning unit 26a, 26b, so that a total of four linear motors are provided for the two workpiece positioning units 26a, 26b.

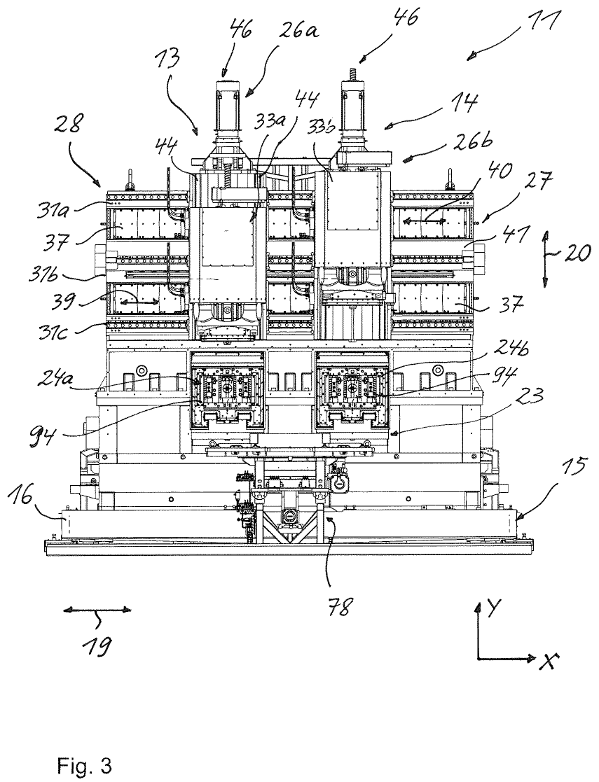

As shown in particular by the combined view of FIGS. 1 and 5, there are components of the total of four linear motors that are available for both workpiece positioning units 26a, 26b. In the example shown, the linear motors are located between adjacent guide rails 31a-c, i.e. between the upper guide rail 31a and the middle guide rail 31b and between the middle guide rail 31b and the lower guide rail 31c. The linear motors each comprise permanent magnet segments 37 (FIG. 3), which are fastened to the front side 29 of the machine bed 28 and thus form the stator part of the linear motor. The permanent magnet segments 37 extend in the X-axis direction 19 essentially over the entire width of the machine bed 28 formed in the X-axis direction 19. The permanent magnet segments 37 are each assigned runner elements 38 arranged on the rear side of the cross slide 32a, 32b and fastened there, which each have at least one electromagnet (not shown) that can be supplied with current. In this respect, there are two runner elements 38 on the cross slide rear wall 34 of the first cross slide 32a, one runner element 38 of which is assigned to the upper permanent magnet segment track and the other runner element 38 to the lower permanent magnet segment track. Similarly, there are two runner elements 38 on the rear wall 34 of the second cross slide 32b, one of which is assigned to the upper permanent magnet segment track 37 and the other to the lower permanent magnet segment track.

By controlling the linear motors accordingly, the two workpiece positioning units 26a, 26b can be moved independently of each other in the X-axis direction 19, wherein the first workpiece positioning unit 26a moves along a so-called X1 axis 39 (FIG. 3) and the second workpiece positioning unit 26b moves along an X2 axis 40 (FIG. 3).

An X-axis measuring system 41 is used to monitor the respective positions of the workpiece positioning units 26a, 26b, which has a measuring rail 42 which is arranged in particular in the region of the central guide rail 35b and also extends in the X-axis direction. The X-axis measuring system 41 can be designed as an optical, inductive or magnetostrictive measuring system.

As already mentioned, the workpiece positioning units 26a, 26b each comprise a Y-slide 33a, 33b in addition to the cross slides 32a, 32b. For this purpose, the first cross slide 32a has a cross slide front wall 43 (FIG. 5) arranged opposite the cross slide rear wall 34, to which two Y-guide rails 44 extending in the Y-axis direction 19 are fastened.

The structure of the Y-slide 33a described below and the associated components of the first workpiece positioning unit 26a are identical to those of the second workpiece positioning unit 26b, so that the following description with reference to the first workpiece positioning unit 26a also applies to the second workpiece positioning unit 26b and the Y-slide 33b arranged there.

As shown in particular in FIG. 5, the Y-slide 32a, 32b has a base body 45 (FIG. 5) which is coupled to the two Y-guide rails 44 in such a way that it can be moved up and down in the Y-axis direction 20 by means of a Y-axis drive 46 arranged on board the workpiece positioning unit 26a. The Y-axis drive 46 is designed as a linear drive, but in contrast to the X-axis drive 36a, a linear drive in the form of a spindle drive is used here. The Y-axis spindle drive has a spindle motor 47 arranged in particular on the upper side of the cross slide 32a, 32b, which rotatably drives a spindle nut 48. The spindle nut 48 is traversed by a Y-axis drive spindle 49, which performs a linear movement as a result of the rotation of the spindle nut 48 without rotating itself. The Y-axis drive spindle 49 is fastened to the underside of the base body 45 so that a linear movement of the Y-axis drive spindle 49 in the Y-axis direction 20 causes a corresponding movement of the base body 45 and thus of the Y-slide 33a, 33b in the Y-axis direction. To determine the position of the Y slide, which, in the case of the first Y slide 33a formed on the first workpiece positioning unit 26a, is movable along a Y1 axis 50, while the second Y slide 33b is movable along a Y2 axis 51 on the other workpiece positioning unit 26b, a Y-axis measuring system 52 is used. Similar to the X-axis measuring system 41, the Y-axis measuring system 52 has a measuring rail 53 arranged in the Y-axis direction 20 in the region of one of the two Y-guide rails 44, with which the actual position of the associated Y-slide 33a, 33b can be detected.

The two Y-slides 33a, 33b each have a rotary table 55 which is rotatable about a first axis of rotation 54 (FIG. 5) extending in the Y-axis direction 20 and is mounted on the base body 45. The first axis of rotation 54 on the first workpiece positioning unit 26a can also be referred to as the B1 axis of rotation and, correspondingly, on the second workpiece positioning unit 26b as the B2 axis of rotation.

The rotational movement of the rotary table 55 is generated by a rotary drive 56 on board the respective Y-slide 33a, 33b. The rotary drive 56 has a drive motor 57 which, via a belt drive (not shown), drives a drive worm 58 which meshes with an output gear 59, which in turn is connected to the turntable 55 in such a way that any rotational movement initiated on the drive gear 59 is transferred to the turntable 55.

The rotational position of the turntable 55 is also detected and monitored by means of a rotational position measuring system 60, which has a measuring sleeve 61 that sits on a hollow shaft 61 connected to the turntable and the gear wheel 59. It is possible to supply electrical energy to the rotary table 55 via the hollow shaft 61, for example by means of electrical lines located in the hollow shaft 61 and passing through it.

An important aspect is that the rotary table 55 has a rotary table interface 62 for coupling with the clamping device 25.

FIG. 7 shows an example design of the clamping device 25, with which a workpiece 12 to be machined is clamped during machining.

The clamping device 25 has a workpiece pallet 64 designed with a counter interface 63 for coupling with the turntable interface 62. As the combined view of FIGS. 5 and 7 shows, the workpiece pallet 64 is connected in a rotationally fixed manner to the rotary table interface 62 with its counter interface 63, so that the clamping device 25 follows the rotational movement about the first axis of rotation 54.

As shown in particular in FIG. 5, there is at least one indexing pin 65 on the turntable interface 62, which can be guided into corresponding bores on the counter interface, thereby achieving correct alignment of the clamping device 25 relative to the turntable 25. The counter interface also has receptacles 67 into which receiving elements on the turntable interface 62 engage, thereby ensuring that the clamping device 25 is fixed to the turntable 55 so that it cannot rotate.

Furthermore, FIG. 7 shows, in particular in a central position, a supply opening 68 into which a pin 69 formed on the turntable interface 62 can engage. This enables the clamping device 25 to be supplied with hydraulic fluid, in particular hydraulic oil, which is fed via the hollow shaft 61 by means of hydraulic channels.

As shown in particular in FIG. 7, the clamping device 25 has, in addition to the workpiece pallet 64, a clamping unit 71 comprising a plurality of workpiece clamping elements 70. The workpiece clamping elements 70 are movable between a release position and a clamping position in which the workpiece to be machined is clamped. The movement of the clamping elements 70 is conveniently generated hydraulically.

It should be noted that the counter interface 63 on the workpiece pallet 64 always has the same design regardless of the design of the clamping unit 71 and therefore always fits onto the rotary table interface 62 on the Y-slide 33a, 33b. The clamping unit 71 and the workpiece clamping elements 70 arranged there, on the other hand, are individually adapted to a workpiece type to be machined, so that it is necessary to replace the clamping device 25 when changing the workpiece type, which is easily possible, as described in more detail below.

The clamping device shown in FIG. 7 is designed as a four-axis clamping device, i.e. the machining unit 13 equipped with such a clamping device performs four-axis machining, whereby the workpiece to be machined can be moved in the X-axis direction, in the Y-axis direction and additionally about the first axis of rotation, and wherein the associated tool slide 24a, 24b with the machining tool 22 is movable in the Z-axis direction 21.

FIG. 8 shows an alternative design of the clamping device 25, i.e. a different type of clamping device, which is designed here as a five-axis clamping device. In contrast to the 4-axis clamping device shown in FIG. 7, the five-axis clamping device shown in FIG. 8 has an additional axis of rotation, i.e. a second axis of rotation 72, which extends in the Z-axis direction 21 in the position of use. This clamping device 25 also has a workpiece pallet 64 with a counter interface 63, which is exactly identical to the counter interface of the four-axis clamping device and serves to connect to the rotary table interface 62. However, in contrast to the four-axis clamping device, the clamping unit 71 is constructed differently. For this purpose, the clamping unit has a clamping unit base body 73 on which a clamping shaft 74 is mounted so as to be rotatable about the second axis of rotation 72.

Here too, workpiece clamping elements 70 are provided, which are conveniently hydraulically actuated and arranged on the outer surface of the clamping shaft 74. The workpiece 12 to be machined is placed on the clamping shaft 74, i.e. the workpiece 12 is a hollow profile that can be placed on the clamping shaft 74. The rotational movement of the clamping shaft 74 is generated by a further rotational drive 75, which is located on board the clamping device 25. An energy transmission interface 76 located on the rotary table and interacting with an energy transmission counter-interface 77, which is arranged in particular on the peripheral surface of the tool pallet 64, serves to supply energy to this rotary drive 75.

The machining centre 11 also has an exexchange shuttle 78 for exchanging workpieces 12 or clamping devices 25. The exexchange shuttle 78 can be moved between an exchange position (not shown) located in the machining zone 23 and a standby position 79 (FIG. 1), in particular linearly in the Z-axis direction 21. The machining zone 23 of the two machining units 13, 14 is enclosed by an enclosure (not shown). Only the lower part of the enclosure in the form of a collection basin 80 is shown in FIG. 1, in which cooling lubricant and chips are collected and can then be transported out of the collection basin 80 by means of a conveyor device (not shown). No machining of the workpieces takes place in the exchange position of the exchange shuttle 78, and the exchange shuttle 78 is therefore moved into the machining zone 23 via an openable gate.

The exchange shuttle 78 is designed to take over either at least one machined workpiece 12 or at least one clamping device to be replaced in the exchange position, or to transfer at least one raw workpiece or at least one clamping device 25 to be replaced to at least one workpiece positioning unit 26a, 26b.

As shown in particular in FIG. 1, the exchange shuttle 78 has a shuttle frame 81 which is fixed in position on the ground, for example on a support, in particular outside the basic rack 15, and on the upper side of which two shuttle guide rails 83 are formed, which are aligned parallel to each other and extend in the Z-axis direction 21. A shuttle slide 82 is guided in a linearly movable manner on the shuttle guide rails 83 and can then be moved between the standby position and the change position, in which it is moved into the processing zone 23. A linear drive, for example in the form of a shuttle spindle drive 84, arranged in particular on board the exchange shuttle 78, is responsible for the linear movement of the shuttle carriage 82.

The shuttle slide 82 in turn has a rotary indexing table 85 which can be rotated about a shuttle axis of rotation 86 (FIG. 4) extending in the Y-axis direction 20.

A rotary drive (not shown) located on board the exexchange shuttle 78 is responsible for initiating the rotary movement on the rotary indexing table 85. In the example shown, there are four loading stations 87a-d on the top of the rotary indexing table 85, which are equipped with either workpiece holders (not shown) or fixture holders (not shown). During a workpiece change, there are usually four workpiece holders on the assigned loading stations 87a-d of the rotary indexing table 85. In the change position moved into the machining zone 23, it is possible that the loading stations 87a, 87b moved into the change position carry unloaded workpiece holders, for example, so that machined workpieces can be transferred to the workpiece holder of the exchange shuttle 78. It is possible to synchronise the transfer of the workpieces to be machined, i.e. a finished workpiece from the first machining unit 13 and a finished workpiece from the second machining unit 14 are transferred to the exchange shuttle 78 at the same time.

In this changeover variant, the other loading stations 87c, 87d of the rotary indexing table 85, which are not moved into the machining zone 23, again contain workpiece holders, but these are loaded with raw workpieces.

After the machined workpieces 12 have been transferred, the rotary indexing table 85 is rotated through 180°, whereby it is expedient to first move the shuttle slide 82 a short distance out of the machining zone 23 so that the rotary movement can be carried out. After rotation, the two workpiece holders loaded with raw workpieces are assigned to the two workpiece positioning units 26a, 26b. By subsequently moving the shuttle slide 82 into the exchange position, the raw workpieces can then be transferred to the respective workpiece positioning units or the clamping devices 25 located there.

As already mentioned, each machining unit 13, 14 has a tool slide 24a, 24b, which can be moved linearly in the Z-axis direction 21 with the aid of a Z-axis guide device 88 between the machining zone 23, in which machining of the workpiece 12 takes place with the machining tool 22 arranged on the tool slide 24a, 24b, and a tool change position (not shown) in the Z-axis direction 21.

As shown in particular in FIG. 6, the Z-axis guide device 88 of a respective machining unit 13, 14 has two Z-axis guide rails 89 aligned parallel to each other, on which the associated tool slide 24a, 24b can be moved linearly between the machining zone and the tool change position.

The tool slide 24a of the first machining unit 13 is therefore guided so that it can move linearly about a Z axis 90, and the tool slide 24b of the second machining unit is guided so that it can move linearly about a Z2 axis 91.

Each of the two tool slides 24a, 24b has a drive spindle 92 (FIG. 5) that can be driven in a rotary motion and provides the drive energy for the machining tool 22 located on board the tool slide 24a, 24b.

The rotational movement of the drive spindle 92 is generated by a drive motor 93 located on board the respective tool slide 24a, 24b.

As shown in particular in FIG. 5, the respective tool slide 24, 24b has a tool interface 94 on the front side facing the machining zone 23, which interacts with a counter interface 95 on the machining tool 22, whereby the machining tool 22 is held in exactly the right position on the tool slide 24a, 24b and is available for subsequent machining of the workpiece 12 in the machining zone 23.

Here too, it is important to note that the counter interfaces 95 on the machining tools 22 are always identical regardless of the tool geometry and therefore always fit onto the tool interface 94 on the tool slide 24a, 24b.

As shown in particular in FIG. 5, the drive motor 93 for the drive spindle 92 is located in the tool slide 24a, 24b and the drive spindle 92 passes through the tool slide 24a, 24b in the Z-axis direction 21. The rotational movement of the drive spindle 92 is then coupled via a coupling device (not shown) to the machining tool 22, where it is then made available to one or more work spindles, which are optionally equipped with machining tools 22 such as drills or milling cutters.

The linear movement of the tool slides 24a, 24b is generated by a Z-axis drive 96, which in the example shown is designed as a linear drive in the form of a Z-axis spindle drive.

As shown in particular in FIG. 6, the Z-axis drive 96 in the form of the spindle drive has a drive motor 97 which rotatably drives a spindle nut (not shown) which is traversed by a spindle rod 98 and which is driven by the rotational movement of the spindle nut to perform a linear movement in the Z-axis direction 21. As shown in particular in FIG. 5, the spindle rod 98 is connected at its free end to a base carrier 99 of the tool slide 24a, 24b.

Here too, it is important to know, i.e. to determine and monitor, the actual position of the respective tool slide 24a, 24b. For this purpose, a Z-axis measuring system 100 is used, with a measuring tape or a measuring rail 101 running parallel to the Z-axis guide rails 89, which interacts with a measuring head 102 arranged on the base carrier 99 of the tool slide 24a, 24b. It should be noted that the measuring head 102 is arranged at the front end assigned to the tool interface 94 of the tool slide 24a, 24b, whereby the influence of the thermal expansion of the tool slide 24a, 24b occurring during machining can be minimised.

The machining centre 11 also has a tool changer 103, with which a tool change can be carried out, in particular synchronously, on the first tool slide 24a and in the second tool slide 24b when these are in the tool change position.

An important aspect is that the tool changer 103 can be rotated by means of a rotary drive device 104 about a changer axis of rotation 105 (FIG. 4) between a tool magazine, in particular two tool magazines 106a, 106b and the associated tool slide 24a, 24b for the transfer or reception of machining tools 22.

As shown in particular in FIG. 1, the tool changer 103 has a base body 107, which in the example shown is designed to be cuboid or cubic. The base body 107 has an outer surface which, in the example of the cubic base body, consists of four surface sections at 90° to each other.

The tool changer 103 also has at least two, in the example shown at least four and in particular eight change arms 109, which are each assigned to one of the tool slides 24a, 24b and each have a changer clamping device 110.

In the example shown, several pairs of change arms 111a-d are formed on the base body 107 of the tool changer 103, each pair of change arms 111a-d being assigned to one of the outer surface sections of the outer surface 108 of the base body 107. The changer arms 109 are each movable between a working position (not shown) in which a working tool 22 can be transferred to or from the tool slide 24a, 24b or to or from the tool magazine 106a, 106b, and a transit position 112 in which the tool changer 103 can be rotated about the changer axis of rotation 105 and be movable along the Y-axis direction 20.

As shown in particular in FIG. 4, the rotary drive device 104 of the tool changer 103 has a drive motor 113 which rotatably drives a drive shaft (not shown) which converts the rotational movement of the drive shaft into a rotary movement of the tool changer 103 about the changer axis of rotation 105 via a gear transmission 114. The two tool magazines 106a, 106b are located to the left and right of the tool changer 103, whereby the changer can access them alternately in a manner described in more detail below.

The tool magazines 106a, 106b are identical in design. They each have a magazine frame 115 on which a tool conveyor device 116 is arranged. The tool conveyor device 116 has a conveyor element that can be driven by a magazine drive 117 and is designed as a conveyor chain in the example shown. The conveyor element 118 can be driven along the Z-axis direction by means of the magazine drive 117.

Several tool holders 119 are arranged on the conveyor element for holding machining tools 22. The tool holders 119, which can also be referred to as storage carriages, can be moved by the conveying movement of the conveying element 118 into a tool changing position in which a changing arm 109 of the tool changer 103 interacts with the tool magazine 106a, 106b for tool changing.

The tool conveyor device 116 is designed such that the conveyor element, i.e. in particular the conveyor chain with the tool holders, rotates endlessly via roller bearings. The conveyor element is deflected by two deflectors 120a, 120b, which divide the conveyor element 118 into an upper strand 121 and a lower strand 122, wherein the upper strand 121 is moved towards the processing zone and the lower strand 122 is moved away from the processing zone. Conveniently, one of the deflections 120a is designed as a drive wheel on which the magazine drive 117 is mounted. Conveniently, the other deflection 120b is formed by a track curve which is formed on a guide body, in particular a sword-like guide body, of the tool conveyor device 116, in particular milled into it.

When workpieces 12 are machined using the machining centre 11 according to the invention, the following steps take place:

Raw workpieces are transported to the exchange shuttle 78, i.e. the raw workpieces are located at the assigned loading stations 87a, 87b of the rotary indexing table 85 and are held there by the corresponding workpiece holders.

Depending on the machining specification, the workpieces 12 can be stored in a first clamping or in a second clamping on the workpiece holders, whereby the two clampings differ in the orientation of the workpiece 12, so that, for example, machining points on the circumference of the workpiece 12 can be machined by means of a first clamping, while in a second clamping, machining points on the end faces of the workpiece 12 are available for machining.

The exchange shuttle 78 with the prepared raw workpieces moves linearly into the change position in the machining zone 23 through a previously opened gate in the enclosure. There, the corresponding workpiece positioning units 26a, 26b are already oriented so that the raw workpieces can be transferred by releasing the holders, in particular spring tensioners, on the tool holders and activating the workpiece clamping elements 70 on the clamping devices, whereby the raw workpiece is clamped to the assigned clamping device 25 and is ready for machining. This process can be carried out synchronously with both the workpiece positioning unit 26a of the first machining unit 13 and the workpiece positioning unit 26b of the second machining unit 14. It is not necessary for the raw workpieces at the loading stations of the transfer shuttle 78 to be identical or stored in the same way, i.e. in principle, a raw workpiece of a first type can be transferred to the workpiece positioning unit 26a of the first machining unit 13, while a raw workpiece of a different type is transferred to the second workpiece positioning unit 26b.

Furthermore, it is also possible for the first machining unit 13 to machine a raw workpiece of a first type with a first clamping and for the second machining unit 14 to machine a raw workpiece of the same type with a different clamping.

Furthermore, it is also possible for four-axis machining to be performed on the first machining unit 13 with a corresponding four-axis clamping device 25, while at the same time five-axis machining is performed on the second machining unit 14 with a corresponding five-axis clamping device. The appropriate clamping devices 25 for the raw workpieces to be machined are also provided by the exchange shuttle 78 before the raw workpieces are transferred.

At the same time as the workpieces 12 are transferred, the tool is changed to the machining tool 22 that is suitable and intended for machining the raw workpieces. To this end, the two change arms 109 assigned to the tool slides 24a, 24b, i.e. this change arm pair 111b, first move into the change position and take over the machining tools 22 that are not required, i.e. those to be replaced, from the tool slides 24a, 24b, while at the same time, offset by 90° relative to this, one of the tool magazines 106a, 106b also takes the processing tools 22 to be replaced from the tool holders 119 by moving into the change position. The change arm pairs 111a, 111b on the tool slides 24a, 24b and on the assigned tool magazine 106a then move simultaneously upwards into the transit position 112, where the tool changer 130 then rotates through 90°, so that the tools 22 to be exchanged are transferred to the associated tool slides 24a, 24b and the machining tools 22 to be replaced are transferred to the opposite tool magazine 106b, i.e. to the tool magazine from which the machining tools to be exchanged were not removed.

The change arm pairs 111a, 111b are then moved down again into the change positions so that the processing tools 22 to be changed can be transferred to the tool slides 24a, 24b or the processing tools 22 to be replaced to unloaded tool holders 119 of the tool magazine 106b.

The tool slides 24a, 24b then move from their exchange position in the Z-axis direction 21 towards the machining zone 23 so that the exchanged machining tools 22 enter the machining zone 23, where machining of the previously exchanged raw workpieces can then take place. The tool change and workpiece change processes run simultaneously, so that a changed machining tool is already available when the workpiece change is complete. To machine the raw workpieces, the drive spindles of the tool slides 24a, 24b are then activated so that the work spindles arranged on the machining tool 22 can machine the assigned raw workpiece. When machining the raw workpiece, it is also possible for the machining tool to move in the Z-axis direction 21 while the workpiece arranged on the assigned workpiece positioning unit 26a. 26b can be moved in the X-axis direction 19. Y-axis direction 20 and about the first axis of rotation 54 during four-axis machining and additionally about the second axis of rotation 72 during five-axis machining.

1. A machining centre for the mechanical machining of workpieces, with a first machining unit which has a first tool slide which can be equipped with a machining tool for machining a workpiece arranged in a machining zone and is movable in a Z-axis direction of a coordinate system formed by three mutually perpendicular axis directions X, Y, Z, and a first workpiece positioning unit that can be moved in an X-axis direction and in a Y-axis direction and can be equipped with a clamping device for receiving and clamping the workpiece to be machined, wherein the first tool slide has a drive spindle which can be driven in rotation to provide drive energy for the machining tool, and wherein the clamping device is rotatable about a first axis of rotation, wherein a second machining unit is provided operable independently of the first machining unit, which is arranged adjacent to the first machining unit in the X-axis direction and has a second tool slide movable independently of the first tool slide in the Z-axis direction and a second workpiece positioning unit movable independently of the first workpiece positioning unit in the X-axis direction and the Y-axis direction.

2. The machining centre according to claim 1, wherein the machining units are assigned a common guide device for independent movement in the X-axis direction, wherein the guide device preferably extends along the X-axis direction above the first and second tool slides and wherein, in particular, the guide device has at least one X-guide rail extending in the X-axis direction on which the first and second workpiece positioning units can be moved back and forth independently of one another by means of X-axis drives assigned to the workpiece positioning units.

3. The machining centre according to claim 2, wherein the X-axis drives are designed as linear drives, in particular linear motors.

4. The machining centre according to claim 1, wherein the workpiece positioning units each have a cross slide mounted on the at least one X-guide rail of the guide device so as to be movable in the X-axis direction and a Y-slide mounted on the cross slide so as to be movable in the Y-axis direction, wherein the cross slide preferably has a Y-axis drive, in particular a Y-spindle drive, for driving the associated Y-slide in the Y-axis direction.

5. The machining centre according to claim 4, wherein the workpiece positioning units each have a rotary drive arranged in particular on board the respective Y-slide for initiating a rotary movement on the coupled clamping device about the first axis of rotation, wherein the first axis of rotation preferably extends in the Y-axis direction.

6. The machining centre according to claim 5, wherein the Y-slide each has a base body and a rotary table rotatable about the first axis of rotation and mounted on the base body, wherein the rotary table preferably has a rotary table interface for coupling to the clamping device.

7. The machining centre according to claim 6, wherein the clamping device has a workpiece pallet designed with a counter interface for coupling with the rotary table interface and a clamping unit connected to the workpiece pallet and comprising a clamping unit connected to the workpiece pallet and having a plurality of workpiece clamping elements, wherein the clamping elements are movable between a release position and a clamping position in which the workpiece to be machined is clamped.

8. The machining centre according to claim 1, wherein an exchange shuttle for changing workpieces or clamping devices, wherein the exchange shuttle is movable, in particular linearly movable, between a standby position and a change position located in the machining zone, wherein, in the changing position, either at least one machined workpiece or at least one clamping device to be replaced can be taken over by the exchange shuttle or at least one raw workpiece or at least one clamping device to be replaced can be transferred to at least one workpiece positioning unit.

9. The machining centre according to claim 8, wherein the exchange shuttle has several loading stations for receiving workpiece carriers or device carriers, wherein the workpiece carriers are empty or loaded with workpieces and wherein the device carriers are empty or loaded with clamping devices.

10. The machining centre according to claim 9, wherein the exchange shuttle has a rotary indexing table which is rotatable in particular about a shuttle axis of rotation extending in the Y-axis direction, wherein the exchange shuttle has at least four loading stations, of which, in the change position, two are located in the machining zone in such a way that transfer or takeover is possible, and subsequently, by rotating the rotary indexing table, the two other loading stations can be swung into the machining zone.

11. The machining centre according to claim 10, wherein the exchange shuttle is linearly movable in the Z-axis direction, wherein the workpiece positioning units are arranged between the tool slides and the exchange shuttle.

12. The machining centre according to claim 1, wherein a machining tool coupled to the associated tool slide is movable between the machining zone and a tool change position by means of a Z-axis guide device, wherein the Z-axis guide device preferably has at least one Z-guide rail extending in the Z-axis direction, by means of which the associated tool slide can be moved in the Z-axis direction by means of a Z-axis drive.

13. The machining centre according to claim 1, wherein a tool changer with which a tool change can be carried out, in particular synchronously, on the first tool slide and the second tool slide when these are in the tool change position, wherein the tool changer is preferably mounted between the tool magazine and the tool slide for transfer or reception of machining tools by means of a rotary drive device so as to be rotatable about a changer axis of rotation.

14. The machining centre according to claim 13, wherein the tool changer has at least two change arms, each of which is assigned to one of the tool slides and each have a changer clamping device, wherein the changer arms are preferably each movable between a position of use, in which a machining tool can be transferred to or taken from the tool slide or to or from the tool magazine, and a transit position in which the tool changer can be rotated about the changer axis of rotation, in particular along the Y-axis direction.

15. The machining centre according to claim 14, wherein the tool changer has a base body with an outer surface on which at least two pairs of changing arms are arranged in such a way that the planes spanned by the two change arms of a pair of change arms are at an angle, in particular perpendicular, to each other, wherein preferably one pair of change arms is located on the associated tool magazine and one pair of change arms is located on the tool slide.
